(19) United States
(12) Patent Application Publication
(10) Pub. No.: US 2018/0218342 A1
(43) Pub. Date: Aug. 2, 2018

(54) SERVERS FOR A REWARD-GENERATING DISTRIBUTED DIGITAL RESOURCE FARM AND METHODS FOR CONTROLLING A SERVER FOR A REWARD-GENERATING DISTRIBUTED DIGITAL RESOURCE FARM

(71) Applicant: RAZER (ASIA-PACIFIC) PTE. LTD., SINGAPORE (SG)

(72) Inventors: Zi Yang Lim, Singapore (SG); Chun How Lee, Singapore (SG)

(21) Appl. No.: 15/747,191

(22) PCT Filed: Jul. 28, 2015
(86) PCT No.: PCT/SG2015/050237

§ 371 Date: Jan. 24, 2018

(51) Int. Cl. G06Q 20/06; G06F 9/50; G06F 21/31

(52) U.S. Cl. CPC G06Q 20/0658; G06Q 20/3678; G06F 21/31; G06F 9/5011

(57) ABSTRACT

According to various embodiments, a server for a distributed digital resource farm may be provided. The server may include: a resource information receiver configured to receive information indicating a plurality of computational resources, each computational resource of the computational resources available at a respective computing device; a request receiver configured to receive from a requester a request for performing a computational task; an assigning circuit configured to assign at least a portion of the computation task for performing to at least one of the computing devices; a first payment circuit configured to deduct payment for performing the requested computational task from the requester; and a second payment circuit configured to provide compensation in virtual credits for providing the computational resource to an owner of the computing device assigned for performing at least the portion of the computation task.

### TECHNICAL FIELD

Various embodiments generally relate to servers for a distributed digital resource farm and methods for controlling a server for a distributed digital resource farm.

### BACKGROUND

Computational resources of computing devices are often not fully used, for example if the computing device is in stand-by or shut-off. Owners of such computing devices would appreciate if they could generate value from these unused computational resources.

### SUMMARY OF THE INVENTION

According to various embodiments, a server for a distributed digital resource farm may be provided. The server may include: a resource information receiver configured to receive information indicating a plurality of computational resources, each computational resource of the computational resources available at a respective computing device; a request receiver configured to receive from a requester a request for performing a computational task; an assigning circuit configured to assign at least a portion of the computation task for performing to at least one of the computing devices; a first payment circuit configured to deduct payment for performing the requested computational task from the requester; and a second payment circuit configured to provide compensation in virtual credits for providing the computational resource to an owner of the computing device assigned for performing at least the portion of the computation task.

According to various embodiments, a method for controlling a server for a distributed digital resource farm may be provided. The method may include: receiving information indicating a plurality of computational resources, each computational resource of the computational resources available at a respective computing device; receiving from a requester a request for performing a computational task; deducting payment for performing the requested computational task from the requester; assigning at least a portion of the computation task for performing to at least one of the computing devices; and providing compensation in virtual credits for providing the computational resource to an owner of the computing device assigned for performing at least the portion of the computation task.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. The dimensions of the various features or elements may be arbitrarily expanded or reduced for clarity. In the following description, various embodiments of the invention are described with reference to the following drawings, in which:

FIG. 1 shows a server for a distributed digital resource farm according to various embodiments;

FIG. 2 shows a flow diagram illustrating a method for controlling a server for a distributed digital resource farm according to various embodiments; and

FIG. 3A and FIG. 3B show illustrations of a block-chain utilization for chance-based reward according to various embodiments.

### DETAILED DESCRIPTION

The following detailed description refers to the accompanying drawings that show, by way of illustration, specific details and embodiments in which the invention may be practiced. These embodiments are described in sufficient detail to enable those skilled in the art to practice the invention. Other embodiments may be utilized and structural, and logical changes may be made without departing from the scope of the invention. The various embodiments are not necessarily mutually exclusive, as some embodiments can be combined with one or more other embodiments to form new embodiments.

In this context, the server as described in this description may include a memory which is for example used in the processing carried out in the server. A memory used in the embodiments may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In an embodiment, a “circuit” may be understood as any kind of a logic implementing entity, which may be special purpose circuitry or a processor executing software stored in a memory, firmware, or any combination thereof. Thus, in an embodiment, a “circuit” may be a hard-wired logic circuit or a programmable logic circuit such as a programmable processor, e.g. a microprocessor (e.g. a Complex Instruction Set Computer (CISC) processor or a Reduced Instruction Set Computer (RISC) processor). A “circuit” may also be a processor executing software, e.g. any kind of computer program, e.g. a computer program using a virtual machine code such as e.g. Java. Any other kind of implementation of the respective functions which will be described in more detail below may also be understood as a “circuit” in accordance with an alternative embodiment.

In the specification the term “comprising” shall be understood to have a broad meaning similar to the term “including” and will be understood to imply the inclusion of a stated integer or step or group of integers or steps but not the exclusion of any other integer or step or group of integers or steps. This definition also applies to variations on the term “comprising” such as “comprise” and “comprises”.

The reference to any prior art in this specification is not, and should not be taken as an acknowledgement or any form of suggestion that the referenced prior art forms part of the common general knowledge in Australia (or any other country).

In order that the invention may be readily understood and put into practical effect, particular embodiments will now be described by way of examples and not limitations, and with reference to the figures.

Various embodiments are provided for devices, and various embodiments are provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein. Furthermore, it will be understood that for any device or method described herein, not necessarily all the components or steps described must be enclosed in the device or method, but only some (but not all) components or steps may be enclosed.

The term “coupled” (or “connected”) herein may be understood as electrically coupled or as mechanically coupled, for example attached or fixed or attached, or just in contact without any fixation, and it will be understood that both direct coupling or indirect coupling (in other words: coupling without direct contact) may be provided.

There may be a lack of full utilization of computational processing resources when computers are turned on. This may result in a waste of computational processing resources which may be utilized elsewhere by enterprises which require massive amounts of computational processing resources. According to various embodiments, there may be provided a way to generate value creation among users who utilize computers and for a company to generate revenue streams from farming the aggregated computational resources from existing users through P2P (peer to peer) network and loaning the aggregated computational resources to enterprises via a platform as a service (PaaS) business model offering free to user and pay to use packages.

According to various embodiments, a cloud-based resource farm, for example for allocating dormant computational resources (for example to generate revenue), may be provided.

According to various embodiments, a method of harnessing and redistribution of dormant PC (personal computer) processing resources (for example for generating revenue) may be provided.

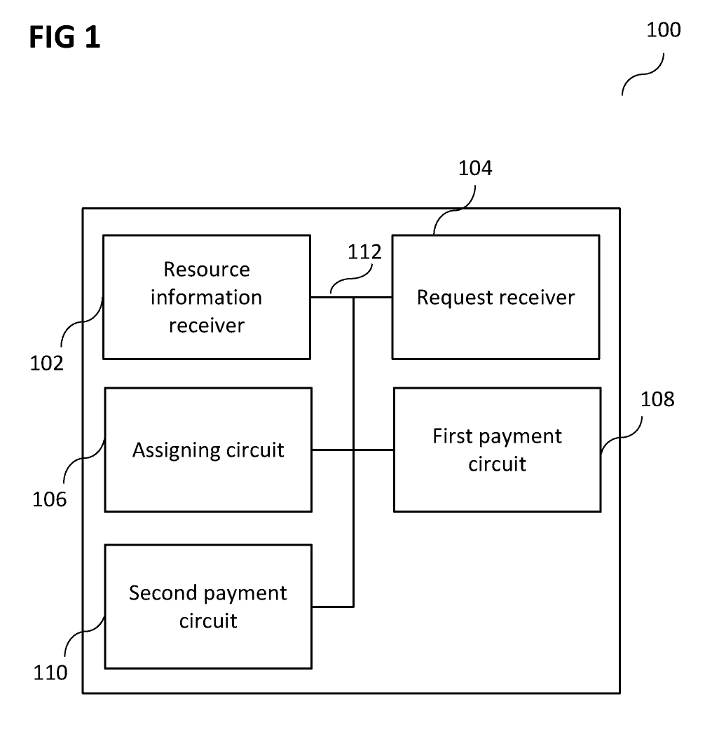

FIG. 1 shows a server 100 for a distributed digital resource farm according to various embodiments. The server 100 may include a resource information receiver 102 configured to receive information indicating a plurality of computational resources (for example a CPU (central processing unit) of a computer, or a GPU (graphics processing unit) of a computing device (in other words: of a computer)), each computational resource of the computational resources available at a respective computing device. The server 100 may further include a request receiver 104 configured to receive from a requester a request for performing a computational task. The server 100 may further include a resource assigning circuit 106 configured to assign at least a portion of the computation task for performing to at least one of the computing devices. The server 100 may further include a first payment circuit 108 configured to deduct payment for performing the requested computational task from the requester. The server 100 may further include a second payment circuit 110 configured to provide compensation in virtual credits for providing the computational resource to an owner of the computing device assigned for performing at least the portion of the computation task. The resource information receiver 102, the request receiver 104, the assigning circuit 106, the first payment circuit 108, and the second payment circuit 110 may be coupled with each other, like indicated by lines 112, for example electrically coupled, for example using a line or a cable, and/or mechanically coupled.

In other words, the server may collect information indicating unused computational resources, and may sell the unused computational resources. For example, according to various embodiments, users who wish to utilize the zMine service will have to purchase zGold or have an external commercial arrangement with Razer if the volume is large. zGold may be purchased and contained as a virtual credits (product) in the zVault which can be expended across a range of service with zMine being one of the option. According to various embodiments, for example, the user may have a 60 minutes animation which he wishes to render into hi-resolution. The user may download the zMine software and initiate a resource request. Depending on the task, it may fall within a zGold pricing category. The zGold may be deducted from the user's zVault. The user may upload the 60 minutes animation via zMine software and this may be processed for distribution for task solving. Contributors of resources who had fulfill the hashing criteria may be awarded with an alternative virtual credits (zSilver or zCopper) which stems from the zGold deducted from the initiator's zVault. The zMine platform may seamlessly establish a resource platform offered using a collaborative crowdsource method for task/problem solving with little interaction from the Razer enterprise. A complex request for services may be arranged commercially apart from this platform but the way the task/problem is solved may still leverage on the distributed digital resource farm.

According to various embodiments, the second payment circuit 110 may be configured to provide compensation based on a block-chain distribution.

According to various embodiments, the assigning circuit 106 may be configured to assign identical portions of the computational task to a plurality of the computing devices.

According to various embodiments, the assigning circuit 106 may be configured to determine which of the plurality of the computing devices first provides a result.

According to various embodiments, the assigning circuit 106 may be configured to determine whether results provided by the plurality of the computing devices are identical.

According to various embodiments, the information may indicate for each computational resource an amount of computational operators provided by the respective computational resource.

According to various embodiments, the information may indicate for each computational resource a specification of the computing system providing the respective computational resource.

According to various embodiments, the information may indicate for each computational resource an amount of operations per second provided by the respective computational resource.

According to various embodiments, the information may indicate for each computational resource a total time for which the respective computational resource is available.

According to various embodiments, the information may indicate for each computational resource a time slot during which the respective computational resource is available.

According to various embodiments, the information may indicate for each computational resource whether the computing resource is available whenever an owner of the computing system providing the respective computational resource is not using all computing resources of the computing system.

According to various embodiments, the information may indicate for each computational resource a price for using the respective computational resource.

According to various embodiments, the price may be set by an owner of the respective computational resource.

According to various embodiments, the assigning circuit 106 may further be configured to provide access data of the requested computational resource to the requester.

According to various embodiments, the access data may include or may be a user name and a password.

According to various embodiments, the first payment circuit 108 may be configured to deduct payment using a real currency.

According to various embodiments, the first payment circuit 108 may be configured to deduct payment using virtual credits.

According to various embodiments, the virtual credits may include or may be zSilver credits.

According to various embodiments, the virtual credits may be exchangeable for products of a pre-determined company.

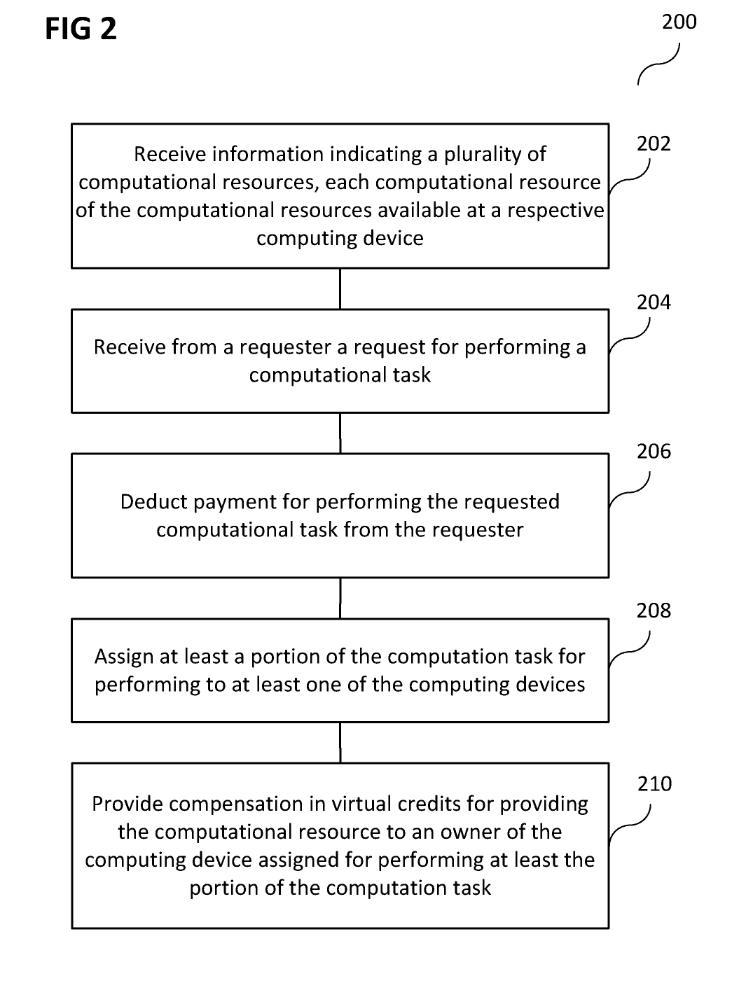

FIG. 2 shows a flow diagram 200 illustrating a method for controlling a server for a distributed digital resource farm according to various embodiments. In 202, information indicating a plurality of computational resources may be received, each computational resource of the computational resources available at a respective computing device. In 204, a request for performing a computational task may be received from a requester. According to various embodiments, the request may automatically be accepted if resource is available. The task may not be transparent to the resource contributor. His reward payment for his partake may be based on the block-chain reward distribution for his effort, like will be described in more detail below. Hence once offer and request by the originator are accepted on zMine, the platform may distribute the task and reward the miners (in other words: contributors) accordingly. In 206, payment may be deducted for performing the requested computational task from the requester. In 208, at least a portion of the computation task may be assigned for performing to at least one of the computing devices. In 210, compensation may be provided in virtual credits for providing the requested computational resource to an owner of the computing device assigned for performing at least the portion of the computation task. According to various embodiments, payment may already have been deducted prior to the acceptance to take on the task. Multiple contributors may be compensated based on block-chain distribution.

According to various embodiments, providing compensation may include or may be providing compensation based on a block-chain distribution

According to various embodiments, the assigning may include or may be assigning identical portions of the computational task to a plurality of the computing devices

According to various embodiments, the method may further include determining which of the plurality of the computing devices first provides a result.

According to various embodiments, the method may further include determining whether results provided by the plurality of the computing devices are identical.

According to various embodiments, the information may indicate for each computational resource an amount of computational operators provided by the respective computational resource.

According to various embodiments, the information may indicate for each computational resource a specification of the computing system providing the respective computational resource.

According to various embodiments, the information may indicate for each computational resource an amount of operations per second provided by the respective computational resource.

According to various embodiments, the information may indicate for each computational resource a total time for which the respective computational resource is available.

According to various embodiments, the information may indicate for each computational resource a time slot during which the respective computational resource is available.

According to various embodiments, the information may indicate for each computational resource whether the computing resource is available whenever an owner of the computing system providing the respective computational resource is not using all computing resources of the computing system.

According to various embodiments, the information may indicate for each computational resource a price for using the respective computational resource.

According to various embodiments, the price may be set by an owner of the respective computational resource.

According to various embodiments, the method may further include providing access data of the requested computational resource to the requester.

According to various embodiments, the access data may include or may be a user name and a password.

According to various embodiments, the method may further include deducting payment using a real currency.

According to various embodiments, the method may further include deducting payment using virtual credits.

According to various embodiments, the virtual credits may include or may be zSilver credits.

According to various embodiments, the virtual credits may be exchangeable for products of a pre-determined company.

As used herein, zGold may be cash purchased virtual credits; zSilver may be enterprise issued rewards credits; the platform for the digital wallet according to various embodiments may also be referred to as zVault; the platform according to various embodiments may be referred to as zMine; the virtual credits may be referred to as zCopper (which may be another virtual credit which is a 1/10 fraction of zSilver). For example, zGold may correspond to US$0.01, zSilver may correspond to US$0.001, and zCopper may correspond to US$0.0001.

According to various embodiments, value may be created in an unutilized resource: dormant computational processing resources amongst a network of users that are using a suite of software services. In exchange for credits or virtual credits (for example ZSilver Credits, which may be a form of virtual credit generated by Razer that can be used to purchase digital content or physical products from Razer or sponsored merchants), the users earn ZSilver credits by lending their CPU processing capacity to Razer.

This value creation in a “resource as money” economy may also promote generation of new users that may gradually accept and use virtual credit (for example ZSilver credits) as a form of “currency” to purchase digital content or products.

On a cloud-based platform according to various embodiments, enterprises may loan computational processing resources for business usage either as a free to use or pay to use package.

According to various embodiments, a method of harnessing and redistribution of dormant computational processing resources on a cloud-based online platform may be provided including the following (for example the following steps):
Aggregating dormant computational processing resources from individual computers connected to a networked environment, for example through a P2P network, the aggregation of computational processing resources from each individual computer activated when the computer user receives virtual credit in exchange for allowing dormant computational processing resources on the computer to be aggregated;
Storing the aggregated dormant computational processing resources on a cloud-based server or to a third party cloud-based rendering provider;
Offering a portion of the dormant computational processing resources for use or for sale to a third party on an online platform.

According to various embodiments, users may be allowed to earn virtual credits (for example Micro-Razer Credits (zSilver)) via algorithm “mining” when they “loan” their PC computational processing resources to Razer.

According to various embodiments, a call for solution or resource will be issued by a third party tapping on Razer's zMine. The request may be dissected and distributed across a connected P2P (peer to peer) network for micro-solutions before it is returned to Razer for compiling and reconciliation for end product delivery.

It will be understood that the process of algorithm mining refers to a mechanism whereby the original owner will engage Razer for the service (zMine). Thereafter Razer will process and send fractions of the initial request to individual machines connected via the zMine distributed network to be rendered, solved or calculated. Upon successful completion of the task, the user will be awarded with zSilver or zCopper. The original owner may be subjected to commercial terms for payment as an enterprise or payment made in zGold to Razer for such a service (as an individual or otherwise).

This process for solving problems via algorithm mining using a P2P distributed network may be in the form of systematic processing (completion of fraction tasks, one-at-a-time, before passing on for the next step—this may be referred to as chain method) or iteration processing (completion of a batch of tasks in simple phases and refining the entire batch over and again until a final iteration is achieved—this may be referred to as iteration method)

Usage of block-chain technology may also be deployed to check 1) who completed the task first, 2) if the task has been completed and 3) completed accurately. In a success scenario, the hash will provide the confirmation for a successfully completed task before it is either returned to Razer or passed onto the next connected P2P machine for next task processing. The success hash acts as a “wax-seal” to determine the integrity of the previously completed task. Without the hashing process, an error will have a dominos effect as it is passed further down the chain which will result in in an incomplete task or inaccurate solution.

This process for problem via algorithm mining using a P2P distributed network may be in the form of systematic processing (completion of fraction tasks, one-at-a-time, before passing on for the next step—chain method) or iteration processing (completion of a batch of tasks in simple phases and refining the entire batch over and again until a final iteration is achieved—iteration method).

For every successful completed task which has its integrity verified, a reward will be provided in the form of either zSilver or zCopper. This may be distributed as a fixed amount or we may introduce an emission rate mechanism to disburse the quantity of reward based on 1) complexity of the micro-task solved and/or 2) an introduction of a virtual credits quantity limit in our self-establish economy which will result in scarcity and appreciation of the specific reward credits overtime.

According to various embodiments, an overlaying mechanism using block-chain technology may be deployed to randomly award a virtual credit reward based on the fulfillment of task verification criteria:

1) If the task has been completed

2) Completed accurately

In a success scenario, a random hash (key) may be provided to all successfully completed tasks before it is either returned to Razer or passed onto the next connected P2P machine for next task processing. The hash may act as a “wax-seal” to determine the integrity of the previously completed task. Without the hashing process, an error may have a dominos effect as it is passed further down the chain which may result in in an incomplete task or inaccurate solution.

According to various embodiments, not all hash (key) may unlock a virtual credit reward. Each random hash may provide the machine (user) with a chance to earn a reward provided in the form of either zSilver or zCopper. Only certain random hash (True Key) may “unlock the rewards”. This may be distributed as a fixed amount or an emission rate mechanism may be introduced to disburse the quantity of reward based on:

1) complexity of the micro-task solved and/or

2) an introduction of a virtual credits quantity limit in our self-establish economy which will result in scarcity and appreciation of the specific reward credits overtime.

Hence a block-chain hash awarded to a user may serve two purpose:

1) Awarded to verify a task is completed accurately before passing on or returned for further processing; and

2) Chance for the user to obtain a reward (Overlay mechanism using Cryptocurrency “lottery hash” mechanism).

In the following, it will be described why according to various embodiments block chain may be utilized for rewarding random users when all users are contributing.

According to various embodiments, block chain may be used to provide a random chance to earn a reward based on the assumption that the input (monetary contribution) by an enterprise using zMine is smaller than the total resource required for the task. This may help to maintain the attractiveness of the virtual credit value rather than diluting it to an insignificant amount.

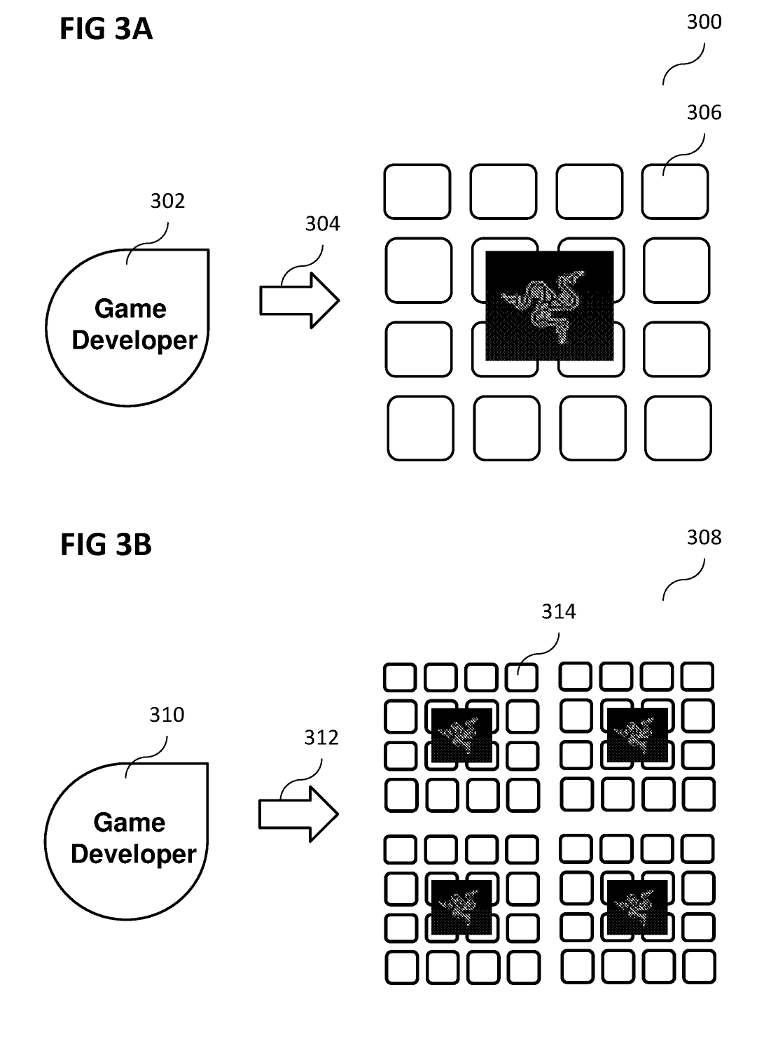

FIG. 3A and FIG. 3B show illustrations of a block-chain utilization for chance-based reward according to various embodiments.

FIG. 3A shows an illustration 300 without block-chain (in other words: without randomize rewarding) according to various embodiments. According to various embodiments, a requester (for example a game developer 302) may engages zMine for a computational task (for example 60 mins game animation rendering) at a pre-determined price (for example USD$1,000). Like illustrated by arrow 304, 100,000 lots of resources 306 within zMine may be engaged for completion in 240 mins. Without Block-chain (in other words: without randomize rewarding), there may be equal distribution of reward, and each user may get USD$0.01 for contributing their resources, so that the rewards get lesser if more resources are engaged to complete the task in a shorter time (US$0.0025 if 400,000 lots). In other words, the amount of reward per resource may be fixed if there is no “chance-base” reward system (built using block-chain). Just in contrast, like will be described below, more resources may be engaged but rewarding may only be provided selectively to selected resources based on “chance”.

It will be understood that USD$ and US$ may be used interchangeably herein.

FIG. 3B shows an illustration 308 with block-chain (in other words: with randomize rewarding) according to various embodiments. According to various embodiments, a requester (for example a game developer 310) may engages zMine for a computational task (for example 60 mins game animation rendering) at a pre-determined price (for example USD$1,000). Like illustrated by arrow 312, 400,000 lots of resources 314 within zMine may be engaged for completion in 60 mins. According to various embodiments, with Block-chain, not all lots may get rewarded, and based on randomize rewarding, 10,000 lots can get up to USD$0.10. In other words, according to various embodiments, it may be tapped on more resources, but the eligible rewards may be randomized to a smaller pool of qualifying resources so that the “reward” is deemed more attractive to participants (US$0.10 compared to US$0.01). As such a higher reward value for resources may be provided based on “chance”.

According to various embodiments, dormant PC's computational power may be consolidated and utilised, for example for rendering and purposes requiring large amount of computational power.

According to various embodiments, devices and methods may be provided for consolidation of processing resources via a P2P network to develop a cloud-based rendering farm.

According to various embodiments, computational capacity may be aggregated and loaned or sold as a service to companies such as medical institutions, game studios, animation studios, digital security companies and other high-tech industry requiring massive computational or processing power for enterprise purposes.

According to various embodiments, virtual credits (for example Micro-Razer Credits (zSilver)) earned (which may be a fraction of zGold) may be rewarded to users for their “mining” effort and trade up to 1/100 of a zGold Value. For a comparison, Bitcoin has a fraction value up to 8 decimal places.

Mining of zSilver via the method according to various embodiments may be subjected to increasing difficulty based on an emission rate which is limited by an annual supply of zSilver in the system. The supply may be increased via an injection of zSilver by Razer into the economy (Faucet) based on business demand. This digital economy may be designed similar to a currency exchange where resource is the currency. This may be different from the economics of commodities which applies scarcity (i.e. Bitcoin and Dogecoin).

According to various embodiments, zSilver at this stage may be experimented as a Digital Currency for physical purchases. Starting from Razer's own line of physical peripherals as a dollar discount offset and expanding into other physical product discounts or as a purchasing currency.

According to various embodiments, a cloud based resource farm may be provided that allocates dormant computational resources to generate revenue. According to various embodiments, a method of harnessing and redistributing dormant personal computer processing resources to generate revenue therefrom may be provided. The method may leverage dormant computational resources, such as from personal computers, to rent, sell, or give for free. The dormant computational resources may be allocated from computers that have been turned on, but are not using all of their computational resource capacity.

According to various embodiments, the method may generate value creation among users who utilize computers and revenue generating means by farming the aggregated computational resources from existing users through P2P network. The method may then redistribute the aggregated computational resources to enterprises via a platform as a service (PaaS) business model offered free for users and with fees to use the different packages.

According to various embodiments, users may be incentivized to loan the unused dormant computational resources by earning credits, which may be used to make purchases with Razer or other companies. This may be a cloud based system, and the owner of the dormant computational resources may decide whether to give the dormant computational resources for free or for a cost.

According to various embodiments, a crypto-credits economy (which may also be referred to as money cloud) may be provided. According to various embodiments, resource borrowing and value-creation for users may be provided, and a “resource as money” economy may be provided for users to earn virtual credits (for example zSilver) by lending their CPU processing capacity (for example to Razer). This may expand acceptance and uses of virtual credits (for example a zSilver beyond Razer's Ecosystem). This may provide value-creation for existing users, and may expand usage and acceptance of virtual credits (for example zSilver).

According to various embodiments, an open community resource PaaS may be provided, for example a resource loan via PaaS business. According to various embodiments, enterprises may loan processing resources for business usage via a platform according to various embodiments. According to various embodiments, the Platform as a Service (PaaS) business model may offer Free-to-use and Pay-to-use packages. According to various embodiments, a new PaaS business model (i.e. Parse, Slack) may be provided. According to various embodiments, a developers community may be aggregated.

Parse is a company owned by Facebook which offers their backend services as a platform solution for game developers. Their three core offerings are Core (hosting, social and background tasks), Push (notifications) and Analytics. It is positioned as an open platform which developers can leverage on for mobile games development and facilitating launch. Slack is a technology start-up which introduced a collaborative web-based platform for team communication anytime, anywhere.

zMine likens to this positioning of both as a PaaS to be able to offer a collaborative open resource platform for task and problem solving both to enterprises and individuals.

According to various embodiments, P2P harnessing and redistribution of dormant PC processing resources for utilisation may be provided.

According to various embodiments, acquisition of users with new demand for virtual credits (for example zSilver) may be provided.

Computational resources of computing devices are often not fully used, for example if the computing device is in stand-by or shut-off. According to various embodiments, devices and methods may be provided so that owners of such computing devices may generate value from these unused computational resources.

According to various embodiments, Razer zVault may include a membership account database (for example based on Razer ID), which may include a user zVault database for zGold including a transaction database (wherein zGold may be topped-up using cash or rebates from hardware purchase) and a user zVault database for zSilver including a transaction database (wherein zSilver may be generated via engagement on software platforms). zGold may be used for game software purchase, in a Razer gift economy (for example for virtual items or activities) or direct purchase within games (which may be referred to as credits exchange). zSilver may be converted to zGold, may be redeemed for peripheral discount code for e-store, or for direct integration within games for generation and usage.

The following examples pertain to further embodiments.

Example 1 is a server for a distributed digital resource farm, the server comprising: a resource information receiver configured to receive information indicating a plurality of computational resources, each computational resource of the computational resources available at a respective computing device; a request receiver configured to receive from a requester a request for performing a computational task; a first payment circuit configured to deduct payment for performing the requested computational task from the requester; an assigning circuit configured to assign at least a portion of the computation task for performing to at least one of the computing devices; and a second payment circuit configured to provide compensation in virtual credits for providing the computational resource to an owner of the computing device assigned for performing at least the portion of the computation task.

In example 2, the subject-matter of example 1 can optionally include that the second payment circuit is configured to provide compensation based on a block-chain distribution.

In example 3, the subject-matter of any one of examples 1 to 2 can optionally include that the assigning circuit is configured to assign identical portions of the computational task to a plurality of the computing devices.

In example 4, the subject-matter of example 3 can optionally include that the assigning circuit is configured to determine which of the plurality of the computing devices first provides a result.

In example 5, the subject-matter of any one of examples 3 to 4 can optionally include that the assigning circuit is configured to determine whether results provided by the plurality of the computing devices are identical.

In example 6, the subject-matter of any one of examples 1 to 5 can optionally include that the information indicates for each computational resource an amount of computational operators provided by the respective computational resource.

In example 7, the subject-matter of any one of examples 1 to 6 can optionally include that the information indicates for each computational resource a specification of the computing system providing the respective computational resource.

In example 8, the subject-matter of any one of examples 1 to 7 can optionally include that the information indicates for each computational resource an amount of operations per second provided by the respective computational resource.

In example 9, the subject-matter of any one of examples 1 to 8 can optionally include that the information indicates for each computational resource a total time for which the respective computational resource is available.

In example 10, the subject-matter of any one of examples 1 to 9 can optionally include that the information indicates for each computational resource whether the computing resource is available whenever an owner of the computing system providing the respective computational resource is not using all computing resources of the computing system.

In example 11, the subject-matter of any one of examples 1 to 10 can optionally include that the assigning circuit is configured to provide access data of the requested computational resource to the requester.

In example 12, the subject-matter of example 11 can optionally include that the access data comprise a user name and a password.

In example 13, the subject-matter of any one of examples 1 to 12 can optionally include that the first payment circuit is configured to deduct payment using a real currency.

In example 14, the subject-matter of any one of examples 1 to 13 can optionally include that the first payment circuit is configured to deduct payment using virtual credits.

In example 15, the subject-matter of any one of examples 1 to 14 can optionally include that the virtual credits are exchangeable for products of a pre-determined company.

Example 16 is a method for controlling a server for a distributed digital resource farm, the method comprising: receiving information indicating a plurality of computational resources, each computational resource of the computational resources available at a respective computing device; receiving from a requester a request for performing a computational task; deducting payment for performing the requested computational task from the requester; assigning at least a portion of the computation task for performing to at least one of the computing devices; and providing compensation in virtual credits for providing the computational resource to an owner of the computing device assigned for performing at least the portion of the computation task.

In example 17, the subject-matter of example 16 can optionally include that providing compensation comprises providing compensation based on a block-chain distribution.

In example 18, the subject-matter of any one of examples 16 to 17 can optionally include that the assigning comprises assigning identical portions of the computational task to a plurality of the computing devices.

In example 19, the subject-matter of example 18 can optionally include determining which of the plurality of the computing devices first provides a result.

In example 20, the subject-matter of any one of examples 18 to 19 can optionally include determining whether results provided by the plurality of the computing devices are identical.

In example 21, the subject-matter of any one of examples 16 to 20 can optionally include that the information indicates for each computational resource an amount of computational operators provided by the respective computational resource.

In example 22, the subject-matter of any one of examples 16 to 21 can optionally include that the information indicates for each computational resource a specification of the computing system providing the respective computational resource.

In example 23, the subject-matter of any one of examples 16 to 22 can optionally include that the information indicates for each computational resource an amount of operations per second provided by the respective computational resource.

In example 24, the subject-matter of any one of examples 16 to 23 can optionally include that the information indicates for each computational resource a total time for which the respective computational resource is available.

In example 25, the subject-matter of any one of examples 16 to 24 can optionally include that the information indicates for each computational resource whether the computing resource is available whenever an owner of the computing system providing the respective computational resource is not using all computing resources of the computing system.

In example 26, the subject-matter of any one of examples 16 to 25 can optionally include providing access data of the requested computational resource to the requester.

In example 27, the subject-matter of example 26 can optionally include that the access data comprise a user name and a password.

In example 28, the subject-matter of any one of examples 16 to 27 can optionally include deducting payment using a real currency.

In example 29, the subject-matter of any one of examples 16 to 28 can optionally include deducting payment using virtual credits.

In example 30, the subject-matter of any one of examples 16 to 29 can optionally include that the virtual credits are exchangeable for products of a pre-determined company.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

1. A server for a distributed digital resource farm, the server comprising:
a resource information receiver configured to receive information indicating a plurality of computational resources, each computational resource of the computational resources available at a respective computing device;
a request receiver configured to receive from a requester a request for performing a computational task;
a first payment circuit configured to deduct payment for performing the requested computational task from the requester;
an assigning circuit configured to assign at least a portion of the computation task to at least one computing device of the computing devices; and
a second payment circuit configured to provide compensation in virtual credits to an owner of the at least one computing device assigned for performing at least the portion of the computation task in response to the at least one computing device providing associated computational resource to perform at least the portion of the computation task.

2. The server of claim 1,
wherein the second payment circuit is configured to provide compensation based on a block-chain distribution.

3. The server of claim 1,
wherein the assigning circuit is configured to assign identical portions of the computational task to a plurality of the computing devices.

4. The server of claim 3,
wherein the assigning circuit is configured to determine which of the plurality of the computing devices first provides a result.

5. The server of claim 3,
wherein the assigning circuit is configured to determine whether results provided by the plurality of the computing devices are identical.

6. The server of claim 1,
wherein the information indicates for each computational resource at least one of an amount of computational operators provided by the respective computational resources, a specification of the computing system providing the respective computational resource, an amount of operations per second provided by the respective computational resource, a total time for which the respective computational resource is available, or whether the computing resource is available whenever an owner of the computing system providing the respective computational resource is not using all computing resources of the computing system.

7. (canceled)

8. (canceled)

9. (canceled)

10. (canceled)

11. The server of claim 1,
wherein the assigning circuit is configured to provide access data of the requested computational resource to the requester.

12. The server of claim 11,
wherein the access data comprise a user name and a password.

13. The server of claim 1,
wherein the first payment circuit is configured to deduct payment using a real currency or virtual credits.

14. (canceled)

15. The server of claim 1,
wherein the virtual credits are exchangeable for products of a pre-determined company.

16. A method for controlling a server for a distributed digital resource farm, the method comprising:
receiving information indicating a plurality of computational resources, each computational resource of the computational resources available at a respective computing device;
receiving from a requester a request for performing a computational task;
deducting payment for performing the requested computational task from the requester;
assigning at least a portion of the computation task to at least one computing device of the computing devices; and
providing compensation in virtual credits to an owner of the at least one computing device assigned for performing at least the portion of the computation task in response to the at least one computing device providing associated computational resource to perform at least the portion of the computation task.

17. The method of claim 16,
wherein providing compensation comprises providing compensation based on a block-chain distribution.

18. The method of claim 16,
wherein the assigning comprises assigning identical portions of the computational task to a plurality of the computing devices.

19. The method of claim 18, further comprising:
determining which of the plurality of the computing devices first provides a result.

20. The method of claim 18, further comprising:
determining whether results provided by the plurality of the computing devices are identical.

21. The method of claim 16,
wherein the information indicates for each computational resource at least one of an amount of computational operators provided by the respective computational resources, a specification of the computing system providing the respective computational resource, an amount of operations per second provided by the respective computational resource, a total time for which the respective computational resource is available, or whether the computing resource is available whenever an owner of the computing system providing the respective computational resource is not using all computing resources of the computing system.

22. (canceled)

23. (canceled)

24. (canceled)

25. (canceled)

26. The method of claim 16, further comprising:
providing access data of the requested computational resource to the requester.

27. The method of claim 26,
wherein the access data comprise a user name and a password.

28. The method of claim 16, further comprising:
deducting payment using a real currency or virtual credits.

29. (canceled)

30. The method of claim 16,
wherein the virtual credits are exchangeable for products of a pre-determined company.
